(19) United States
(12) Patent Application Publication
(10) Pub. No.: US 2010/0189361 A1
(43) Pub. Date: Jul. 29, 2010

(54) IMAGE PROCESSING APPARATUS FOR DETECTING COORDINATE POSITIONS OF CHARACTERISTIC PORTIONS OF FACE

(75) Inventors: Masaya Usui, Shiojiri-shi (JP); Kenji Matsuzaka, Shiojiri-shi (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SEIKO EPSON CORPORATION, Shinjuku-ku (JP)

(21) Appl. No.: 12/695,025

(22) Filed: Jan. 27, 2010

(30) Foreign Application Priority Data
Jan. 28, 2009 (JP) 2009-017056

(51) Int. Cl. G06K 9/46

(52) U.S. Cl. 382/201

(57) ABSTRACT

Image processing apparatus and methods are provided for detecting coordinate positions of characteristic portions of a face image in a target image. A method includes identifying a face area of the target image, determining initial coordinate positions for the characteristic portions, determining corrected coordinate positions for the characteristic portions by modifying the initial coordinate positions or previously generated corrected coordinate positions, and identifying the corrected coordinate positions as the coordinate positions of the characteristic portions of the face image.

### CROSS-REFERENCES TO RELATED APPLICATIONS

Priority is claimed under 35 U.S.C. §119 to Japanese Application No. 2009-017056, filed on Jan. 28, 2009 which is hereby incorporated by reference in its entirety.

The present application is related to U.S. application Ser. No. ______, entitled “Specifying Position of Characteristic Portion of Face Image,” filed on ______, (Attorney Docket No. 21654P-026100US); U.S. application Ser. No. ______, entitled “Image Processing Apparatus For Detecting Coordinate Position of Characteristic Portion of Face,” filed on ______, (Attorney Docket No. 21654P-026900US); and U.S. application Ser. No. ______, entitled “Image Processing For Changing Predetermined Texture Characteristic Amount of Face Image,” filed on ______, (Attorney Docket No. 21654P-027000US); each of which are incorporated herein by reference.

### BACKGROUND

1. Technical Field

The present invention relates to an image processing apparatus for detecting the coordinate positions of characteristic portions of a face that are included in a target image.

2. Related Art

An active appearance model technique (also abbreviated as “AAM”) has been used to model a visual event. In the AAM technique, a face image is, for example, modeled by using a shape model that represents the face shape by using positions of characteristic portions of the face and a texture model that represents the “appearance” in an average face shape. The shape model and the texture model can be created, for example, by performing statistical analysis on the positions (coordinates) and pixel values (for example, luminance values) of predetermined characteristic portions (for example, an eye area, a nose tip, and a face line) of a plurality of sample face images. Using the AAM technique, any arbitrary face image can be modeled (synthesized). In addition, the positions of the characteristic portions of faces that are included in an image can be detected (for example, see JP-A-2007-141107).

In the AAM technique, however, it is desirable to improve the efficiency and the processing speed of detecting the position of the characteristic portions of faces that are included in an image.

In addition, it may also be desirable to improve efficiency and processing speed whenever image processing is used to detect the position of the characteristic portions of faces included in images.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description located below.

The present invention provides image processing apparatus and methods for detecting coordinate positions of characteristic portions of a face image. Such image processing apparatus and methods may improve the efficiency and the processing speed of detecting coordinate positions of characteristic portions of a face image included in an image.

Thus, in a first aspect, an image processing apparatus is provided for detecting coordinate positions of characteristic portions of a face image in a target image. The image processing apparatus includes a face area detecting unit that detects an image area that includes at least a portion of a face image as a face area from the target image, an initial position setting unit that sets an initial position of a characteristic point set in the target image, and a characteristic position detecting unit that corrects a setting position of the characteristic point set to the initial position so as to approach the coordinate position of the characteristic portion and detects the corrected setting position as the coordinate position of the characteristic portion. The initial position setting unit sets the initial position of a characteristic point set by using one or more parameters relating to a size, an angle, and a position of the face image in the face area and one or more characteristic amounts representing characteristics of the face image that are prepared in advance. Accordingly, the initial position can be set to an appropriate position. Therefore, the efficiency and the processing speed of a process for detecting coordinate positions of characteristic portions of a face image included in the target image may be improved.

In many embodiments, the initial position setting unit is configured to set the initial positions of a characteristic point set based on one of a plurality of characteristic point sets that are created in advance by using the predetermined values of the parameters and the characteristic amounts. In such a case, since one of the preexisting characteristic point sets is used to set the initial positions of the characteristic points, the coordinate positions of characteristic portions of the face image in the target image can be efficiently detected at a high speed.

In many embodiments, the initial position setting unit is configured to include a generation section that generates an average shape image by transforming a part of the target image corresponding to a characteristic point set for the characteristic portions, and a calculation section that generates a differential image between the average shape image and a reference average face image. The reference average face image has coordinate positions of its characteristic portions based on a plurality of sample images that include known face images. A plurality of candidate points sets for the characteristic portions can be evaluated by generating the above-described differential image for each of the candidate point sets, and calculating the norm of each of the resulting differential images. The initial positions of the characteristic points set can be set based on the average shape image corresponding to the differential image having the smallest value of its norm. In such a case, the coordinate positions of characteristic portions of the face image in the target image can be efficiently detected at a high speed.

In many embodiments, the one or more characteristic amounts include one or more coefficients of a corresponding one or more shape vectors that is acquired by performing principal component analysis on coordinate positions of characteristic portions included in the plurality of sample images. In many embodiments, the initial position setting unit sets the initial coordinate positions by using coefficients of one or more shape vectors out of the shape vectors in descending order of contribution rate for the characteristics of the face image. In such a case, by using the coefficients of one or more shape vectors having high contribution rates for setting the initial positions of the characteristic points, the coordinate positions of characteristic portions of the face image in the target image may be efficiently detected at a high speed.

In many embodiments, the initial position setting unit is configured to set the initial coordinate positions of the characteristic portions by using the characteristic amount that represents face-turn of the face image in the horizontal direction. In such a case, the coordinate positions of characteristic portions of the face image in the target image may be efficiently detected at a high speed.

In many embodiments, the initial position setting unit is configured to set the initial coordinate position by using the characteristic amount that represents face-turn of the face image in the vertical direction. In such a case, the coordinate positions of characteristic portions of the face image in the target image may be efficiently detected at a high speed.

In many embodiments, the characteristic position detecting unit further includes a correction portion that corrects the coordinate positions of the characteristic portions so as to decrease the norm of a differential image between the average shape image corresponding to the initial position and the reference average face image. In many embodiments, the characteristic position detecting unit detects the coordinate positions for which the norm of the differential image becomes equal to or less than a predetermined value so as to identify the corrected coordinate positions as the coordinate positions of the characteristic portions of the face image. Accordingly, the coordinate positions of characteristic portions of the face image in the target image may be efficiently detected at a high speed.

In many embodiments, the characteristic portions include an eyebrow, an eye, a nose, a mouth, and a face line. In such a case, the coordinate positions can be detected accurately.

In another aspect, an image processing apparatus is provided that detects coordinate positions of characteristic portions of a face image in a target image. The image processing apparatus includes a processor and a machine readable memory coupled with the processor that includes instructions that when executed cause the processor to identify a face area of the target image that includes at least a portion of the face image, generate initial coordinate positions for the characteristic portions, generate corrected coordinate positions for the characteristic portions by modifying the initial coordinate positions or previously generated corrected coordinate positions so as to approach the characteristic portions in the target image, and detect the corrected coordinate positions as the coordinate positions of the characteristic portions of the face image. The initial coordinate positions are generated by using one or more predetermined parameters and one or more predetermined characteristic amounts representing characteristics of the face image. The predetermined parameters relate to a size, an angle, or a position of the face image in the face area.

In many embodiments, the initial coordinate positions are generated from one of a plurality of candidate sets of initial coordinate positions that are set in advance by using predetermined values of the parameters and the characteristic amounts.

In many embodiments, the memory further comprises instructions that when executed cause the processor to generate each of a plurality of average shape images from the target image by transforming a part of the target image into a reference average face image shape based on a corresponding set of the candidate sets of initial coordinate positions. In many embodiments, the memory further comprises instructions that when executed cause the processor to generate a differential image between each of the average shape images and a reference average face image having the reference average face image shape, the reference average face image having coordinate positions of its characteristic portions based on a plurality of sample face images. In many embodiments, the memory further comprises instructions that when executed cause the processor to generate the initial coordinate positions from the candidate set of initial coordinate positions corresponding to the differential image having the smallest value for its norm.

In many embodiments, the one or more characteristic amounts include one or more coefficients of a corresponding one or more shape vectors that are acquired by performing principal component analysis on coordinate positions of characteristic portions included in the plurality of sample images. In many embodiments, the initial coordinate positions are generated by using coefficients of one or more shape vectors out of the shape vectors in descending order of contribution rate for the characteristics of the face image.

In many embodiments, the initial coordinate positions are generated by using the characteristic amount that represents face-turn of the face image in the horizontal direction. In many embodiments, the initial coordinate positions are generated by using the characteristic amount that represents face-turn of the face image in the vertical direction.

In many embodiments, the corrected coordinate positions are generated so as to decrease the norm of a differential image between the reference average face image and an average shape image corresponding to the initial coordinate positions or previously generated corrected coordinate positions. In many embodiments, the corrected coordinate positions are detected as the coordinate positions of the characteristic portions of the face image when the norm of the differential image is equal to or less than a predetermined value.

In many embodiments, the characteristic portions include an eyebrow, an eye, a nose, a mouth, and a face line.

In another aspect, an image processing method is provided for detecting coordinate positions of characteristic portions of a face image in a target image. The image processing method includes identifying a face area of the target image that includes at least a portion of the face image, determining initial coordinate positions for the characteristic portions, determining corrected coordinate positions for the characteristic portions by modifying the initial coordinate positions or previously generated corrected coordinate positions so as to approach the characteristic portions in the target image, and identifying the corrected coordinate positions as the coordinate positions of the characteristic portions of the face image. The initial coordinate positions are determined by using one or more predetermined parameters and one or more predetermined characteristic amounts representing characteristics of the face image. The predetermined parameters relate to a size, an angle, or a position of the face image in the face area.

In addition, the invention can be implemented in various forms and, for example, may be implemented as a printer, a digital still camera, a personal computer, a digital video camera, and the like. In addition, the invention can be implemented in the forms of an image processing method, an image processing apparatus, a method of detecting the positions of characteristic portions, an apparatus for detecting the positions of characteristic portions, a facial expression determining method, a facial expression determining apparatus, a computer program for implementing the functions of the above-described methods or apparatuses, a recording medium having the computer program recorded thereon, a data signal implemented in a carrier wave including the computer program, and the like.

For a fuller understanding of the nature and advantages of the present invention, reference should be made to the ensuing detailed description and accompanying drawings.

### BRIEF DESCRIPTION OF THE DRAWINGS

The invention is described below with reference to the accompanying drawings, wherein like numbers reference like elements.

FIG. 1 is an explanatory diagram schematically showing the configuration of a printer as an image processing apparatus in accordance with many embodiments.

FIG. 2 is a flowchart showing steps of an active appearance model (AAM) setting process, in accordance with many embodiments.

FIG. 3 is an explanatory diagram showing exemplary sample images, in accordance with many embodiments.

FIG. 4 is an explanatory diagram illustrating the setting of characteristic points for a sample image, in accordance with many embodiments.

FIG. 5 is an explanatory diagram showing exemplary coordinates of the characteristic points set in the sample image of FIG. 4, in accordance with many embodiments.

FIGS. 6A and 6B are explanatory diagrams showing an exemplary average shape, in accordance with many embodiments.

FIGS. 7A, 7B, and 7C are explanatory diagrams illustrating relationships between shape vectors, shape parameters, and face shapes, in accordance with many embodiments.

FIG. 8 is an explanatory diagram showing an example of a warp method for transforming part of a sample image into an average shape image having the shape of a reference average face image, in accordance with many embodiments.

FIG. 9 is an explanatory diagram showing an example of an average face image.

FIG. 10 is a flowchart showing steps of a face characteristic position detecting process in accordance with many embodiments.

FIG. 11 is an explanatory diagram showing an example of the result of detecting a face area in a target image.

FIG. 12 is a flowchart showing steps of an initial position setting process for the characteristic points in accordance with many embodiments.

FIGS. 13A and 13B are explanatory diagrams showing an example of temporary setting positions of the characteristic points by changing the values of global parameters.

FIG. 14 is an explanatory diagram showing an example of average shape images.

FIG. 15 is an explanatory diagram showing an example of a temporary initial position of the characteristic points by changing the values of characteristic amounts.

FIG. 16 is a flowchart showing steps of a process for correcting the characteristic point setting position in accordance with many embodiments.

FIG. 17 is an explanatory diagram showing an example of the result of a face characteristic position detecting process.

### DETAILED DESCRIPTION

In the following description, various embodiments of the present invention are described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

### Image Processing Apparatus

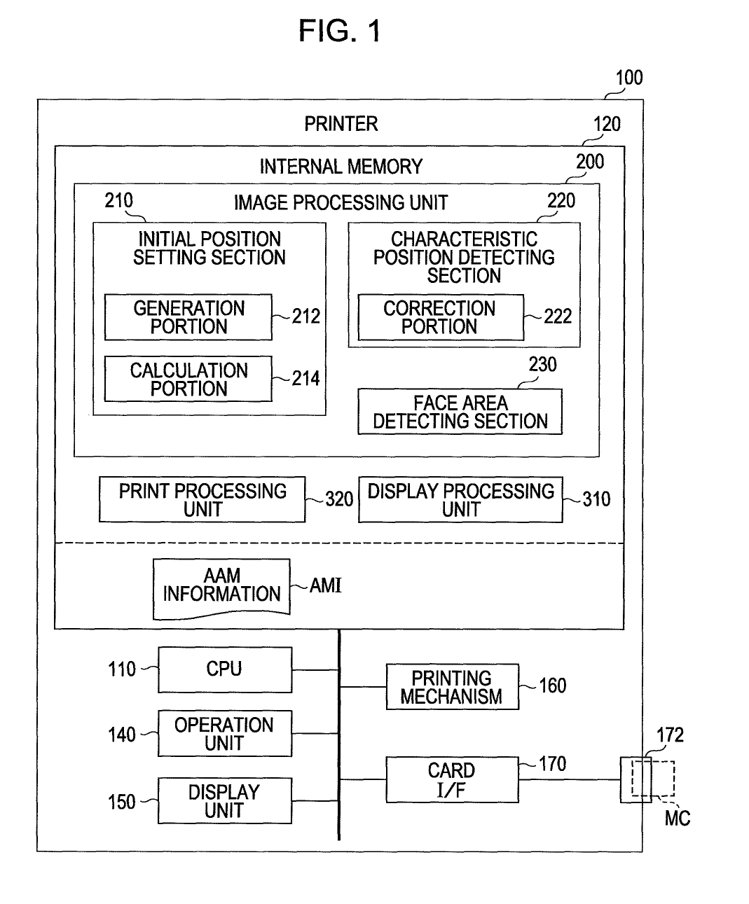

Referring now to the drawings, in which like reference numerals represent like parts throughout the several views, FIG. 1 is an explanatory diagram schematically showing the configuration of a printer 100 as an image processing apparatus, in accordance with many embodiments. The printer 100 can be a color ink jet printer corresponding to so-called direct printing in which an image is printed based on image data that is acquired from a memory card MC or the like. The printer 100 includes a CPU 110 that controls each unit of the printer 100, an internal memory 120 that includes a read-only memory (ROM) and a random-access memory (RAM), an operation unit 140 that can include buttons and/or a touch panel, a display unit 150 that can include a display (e.g., a liquid crystal display), a printing mechanism 160, and a card interface (card I/F) 170. In addition, the printer 100 can include an interface that is used for performing data communication with other devices (for example, a digital camera or a personal computer). The constituent elements of the printer 100 are interconnected through a communication bus.

The printing mechanism 160 performs a printing operation based on print data. The card interface 170 is an interface that is used for exchanging data with a memory card MC inserted into a card slot 172. In many embodiments, an image file that includes the image data is stored in the memory card MC.

In the internal memory 120, an image processing unit 200, a display processing unit 310, and a print processing unit 320 are stored. The image processing unit 200 can be a computer program and performs a face characteristic position detecting process by being executed by a CPU 110 under a predetermined operating system. The face characteristic detecting process detects the positions of predetermined characteristic portions (for example, an eye area, a nose tip, and a face line) in a face image. The face characteristic detecting process is described below in detail. In addition, various functions are implemented as the CPU 110 also executes the display processing unit 310 and the printing processing unit 320.

The image processing unit 200 includes an initial position setting section 210, a characteristic position detecting section 220, and a face area detecting section 230 as program modules. The initial position setting section 210 includes a generation portion 212 and a calculation portion 214. In addition, the characteristic position detecting section 220 includes a correction portion 222. The functions of these units, sections, and portions will be described in detail in a description of the face characteristic position detecting process described below.

The display processing unit 310 can be a display driver that displays a process menu, a message, an image, and/or the like on the display unit 150 by controlling the display unit 150. The print processing unit 320 can be a computer program that generates print data based on the image data and prints an image based on the print data by controlling the printing mechanism 160. The CPU 110 implements the functions of these units by reading out the above-described programs (the image processing unit 200, the display processing unit 310, and the print processing unit 320) from the internal memory 120 and executing the programs.

In addition, AAM information AMI is stored in the internal memory 120. The AAM information AMI is information that is set in advance in an AAM setting process described below and is referred to in the face characteristic position detecting process described below. The content of the AAM information AMI is described in detail in a description of the AAM setting process provided below.

### AAM Setting Process

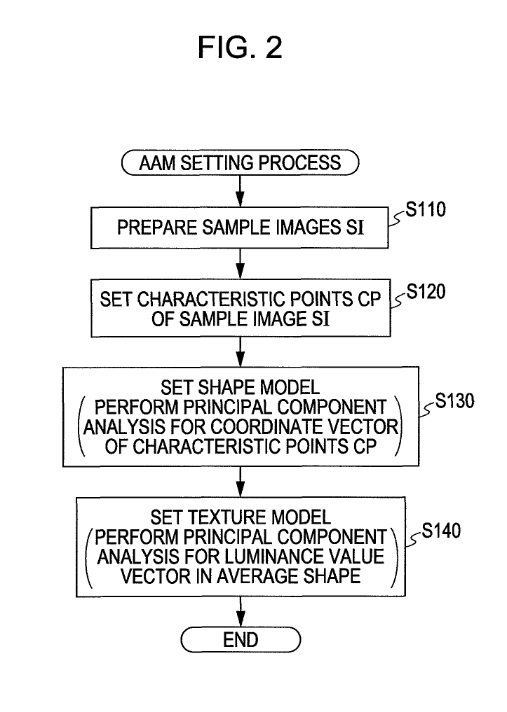

FIG. 2 is a flowchart showing steps of an AAM setting process in accordance with many embodiments. The AAM setting process creates shape and texture models that are used in an image modeling technique called an Active Appearance Model (AAM). In many embodiments, the AAM setting process involves user input.

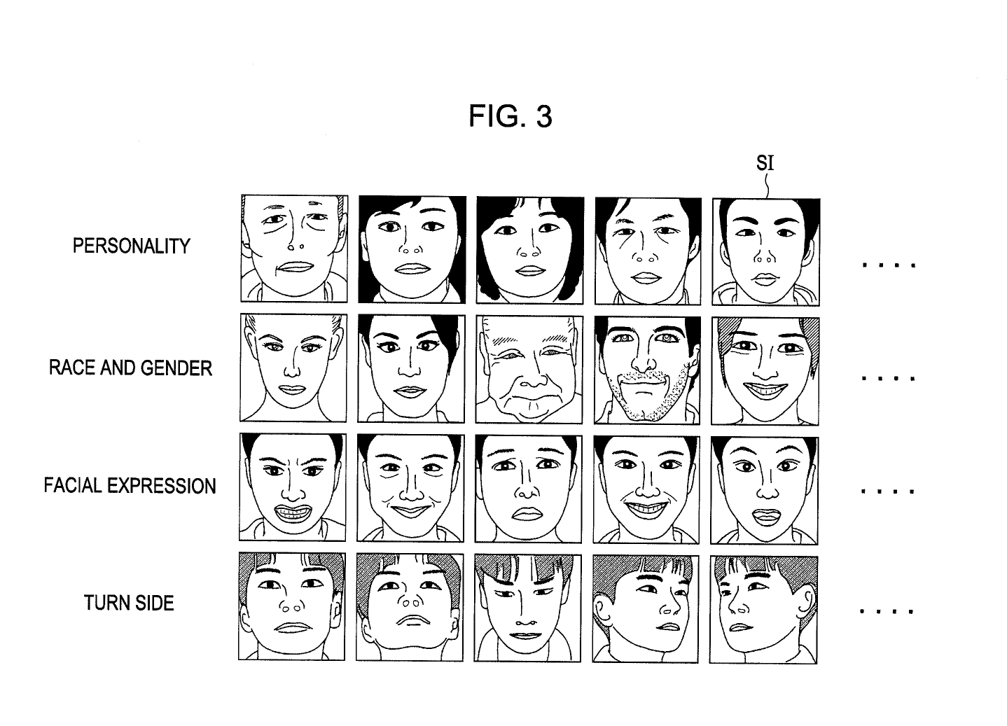

First, a plurality of images are prepared that includes people's faces as sample images SI (Step S110). FIG. 3 is an explanatory diagram showing exemplary sample images SI. As illustrated in FIG. 3, the sample images SI can be prepared such that the sample face images having different attributes for various attributes such as personality, race, gender, facial expression (anger, laughter, troubled, surprised, or the like), and a direction (front-side turn, upward turn, right-side turn, left-side turn, or the like). When the sample images SI are prepared in such a manner, a wide variety of face images can be modeled with high accuracy by using the AAM technique. Accordingly, the face characteristic position detecting process (described below) can be performed with high accuracy for a wide variety of face images. The sample images SI are also referred to herein as face images for learning.

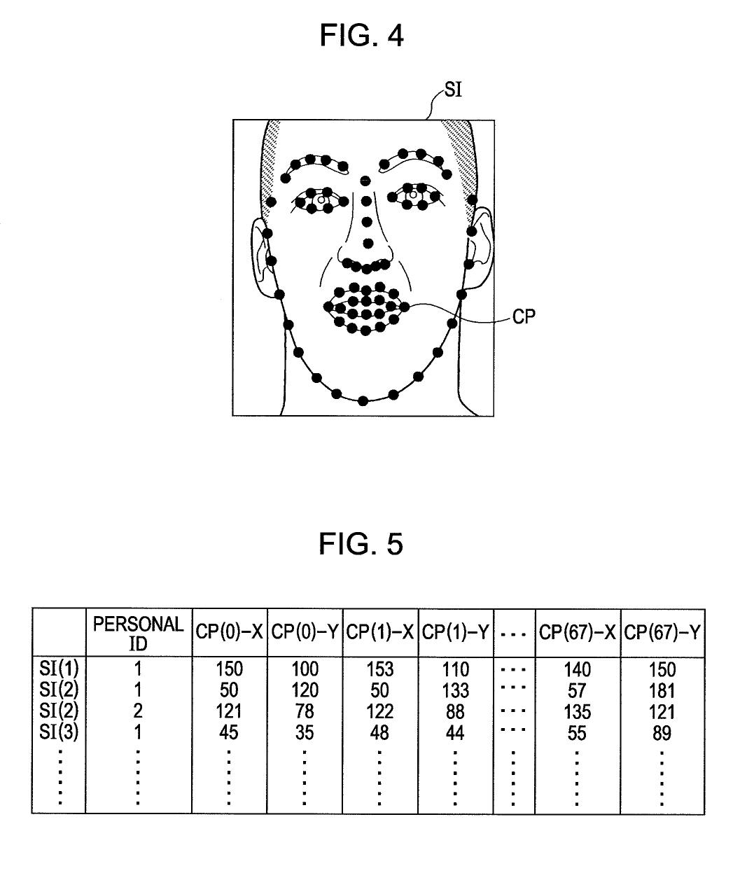

Then, the characteristic points CP are set for each sample face image SI (Step S120). FIG. 4 is an explanatory diagram illustrating the setting of characteristic points CP of a sample image SI. The characteristic points CP are points that represent the positions of predetermined characteristic portions of the face image. In many embodiments, 68 characteristic points CP are located on portions of a person's face that include predetermined positions on the eyebrows (for example, end points, four-division points, or the like; the same in the description below), predetermined positions on the contour of the eyes, predetermined positions on contours of the bridge of the nose and the wings of the nose, predetermined positions on the contours of upper and lower lips, and predetermined positions on the contour (face line) of the face. In other words, predetermined positions of contours of organs (eyebrows, eyes, a nose, and a mouth) of a face and the face that are commonly included in a person's face are set as the characteristic portions. As shown in FIG. 4, the characteristic points CP can be set (disposed) to the illustrated 68 positions that represent characteristic portions of each sample face image SI. The characteristic portions can be designated, for example, by an operator of the image processing apparatus. The characteristic points CP correspond to the characteristic portions, and accordingly it can be represented that the disposition of the characteristic points CP in a face image specifies the shape of the face.

The position of each characteristic point CP in a sample image SI can be specified by coordinates. FIG. 5 is an explanatory diagram showing exemplary coordinates of the characteristic points CP set in the sample image SI. In FIG. 5, SI(j) (j=1, 2, 3 . . . ) represents each sample image SI, and CP(k) (k=0, 1, . . . , 67) represents each characteristic point CP. In addition, CP(k)-X represents the X coordinate of the characteristic point CP(k), and CP(k)-Y represents the Y coordinate of the characteristic point CP(k). The coordinates of the characteristic points CP can be set by using a predetermined reference point (for example, a lower left point in an image) in a sample image SI that has been normalized for the face size, the face tilt (a tilt within the image surface), and the positions of the face in the X direction and the Y direction. In addition, a case where a plurality of person's images is included in one sample image SI is allowed (for example, two faces are included in a sample image SI(2)), and the persons included in one sample image SI are specified by personal IDs.

Subsequently, a shape model of the AAM is set (Step S130). In particular, the face shape s that is specified by the positions of the characteristic points CP is modeled by the following Equation (1) by performing a principal component analysis for a coordinate vector (see FIG. 5) that is configured by the coordinates (X coordinates and Y coordinates) of 68 characteristic points CP in each sample image SI. In addition, the shape model is also called a disposition model of characteristic points CP.

$$\begin{matrix}Equation ( 1 ) & \\ s = {s}_{0} + {\sum }_{i = 1}^{n} {p}_{i} {s}_{i} & ( 1 )\end{matrix}$$

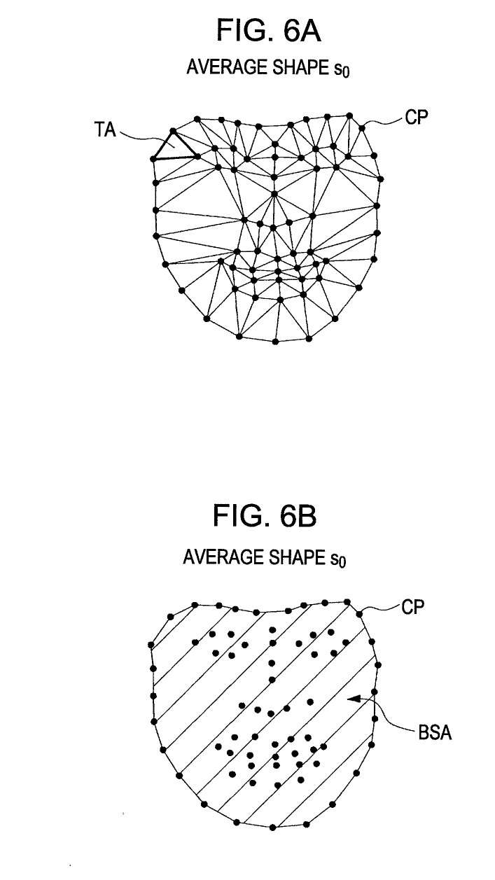

In the above-described Equation (1), s₀ is an average shape. FIGS. 6A and 6B are explanatory diagrams showing an example of the average shape s₀. As shown in FIGS. 6A and 6B, the average shape s₀ is a model that represents an average face shape that is specified by average positions (average coordinates) of each characteristic point CP of the sample image SI. An area (denoted by being hatched in FIG. 6B) surrounded by straight lines enclosing characteristic points CP (characteristic points CP corresponding to the face line, the eyebrows, and a region between the eyebrows; see FIG. 4) located on the outer periphery of the average shape s₀ is referred to herein as an “average shape area BSA”. The average shape s₀ is set such that, as shown in FIG. 6A, a plurality of triangle areas TA having the characteristic points CP as their vertexes divide the average shape area BSA into mesh shapes.

In the above-described Equation (1) representing a shape model, sᵢ is a shape vector, and pᵢ is a shape parameter that represents the weight of the shape vector sᵢ. The shape vector sᵢ can be a vector that represents the characteristics of the face shape s. The shape vector sᵢ can be an eigenvector corresponding to an i-th principal vector acquired by performing principal component analysis. As shown in the above-described Equation (1), a face shape s that represents the disposition of the characteristic points CP can be modeled as a sum of an average shape s₀ and a linear combination of n shape vectors sᵢ. By appropriately setting the shape parameter pᵢ for the shape model, the face shapes s in a wide variety of images can be reproduced.

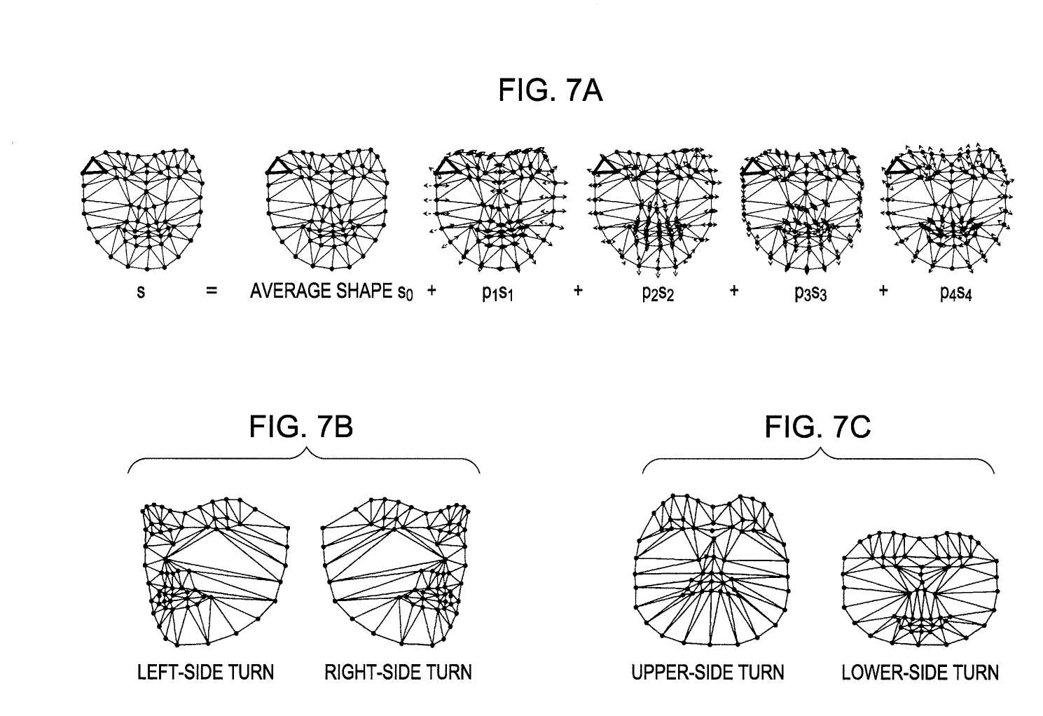

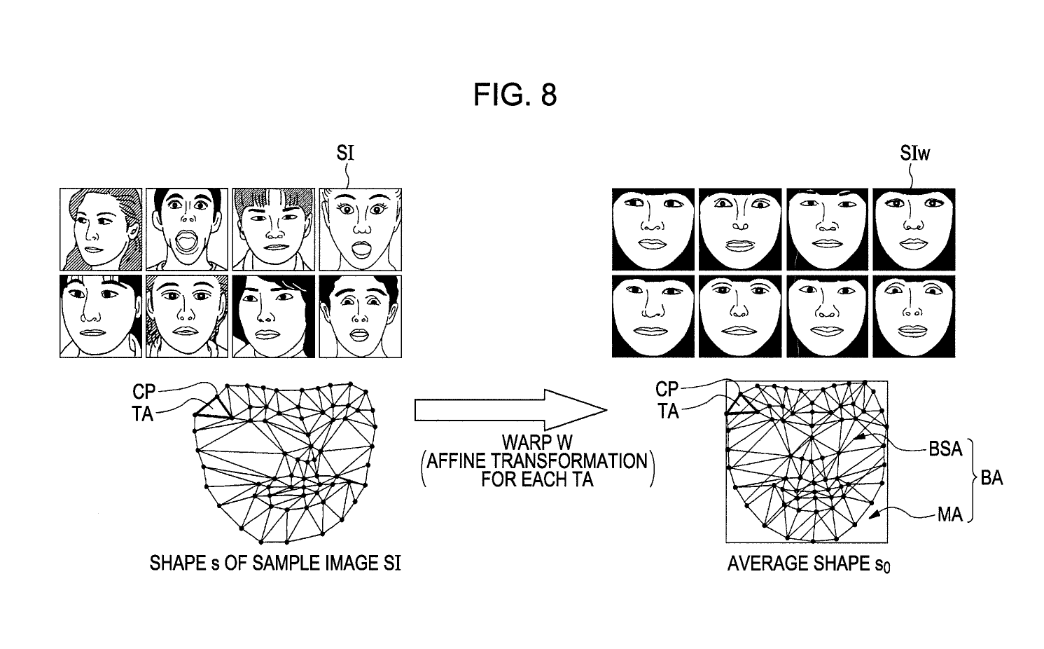

FIGS. 7A, 7B, and 7C are explanatory diagrams illustrating the relationship between the shape vector sᵢ, the shape parameter pᵢ, and the face shape s. As shown in FIG. 7A, in order to specify a face shape s, n (n=4 in FIG. 7) eigenvectors that are set based on the accumulated contribution rates in the order of eigenvectors corresponding to principal components having higher contribution rates are used as the shape vectors sᵢ. Each of the shape vectors Sᵢ, as denoted by arrows shown in FIG. 7A, corresponds to the moving direction and the amount of movement of each characteristic point CP. In many embodiments, a first shape vector sᵢ that corresponds to a first principal component having the highest contribution rate is a vector that is approximately correlated with the horizontal orientation of a face. Accordingly, by changing the value of the shape parameter p₁, as shown in FIG. 7B, the turn of the face shape s in the horizontal direction is changed. A second shape vector s₂ corresponding to a second principal component that has the second highest contribution rate is a vector that is approximately correlated with the vertical orientation of a face. Accordingly, by changing the value of the shape parameter p₂, as shown in FIG. 7C, the turn of the face shape s in the vertical direction is changed. In addition, a third shape vector s₃ corresponding to a third principal component having the third highest contribution rate is a vector that is approximately correlated with the aspect ratio of a face shape, and a fourth shape vector s₄ corresponding to a fourth principal component having the fourth highest contribution rate is a vector that is approximately correlated with the degree of opening of a mouth. As described above, the values of the shape parameters represent characteristics of a face image such as a facial expression and the turn of the face. The “shape parameters” are also referred to herein as characteristic amounts.

In many embodiments, the average shape s₀ and the shape vector sᵢ that are set in the shape model setting step (Step S130) is stored in the internal memory 120 as the AAM information AMI (FIG. 1).

Subsequently, a texture model of the AAM is set (Step S140). In many embodiments, the process of setting the texture model begins by applying an image transformation (also referred to herein as “warp W”) to each sample image SI, so that set positions of the characteristic points CP in each of the transformed sample images SI are identical to those of the characteristic points CP in the average shape s₀.

FIG. 8 is an explanatory diagram showing an example of a warp W method for a sample image SI. For each sample image SI, similar to the average shape s₀, a plurality of triangle areas TA that divides an area surrounded by the characteristic points CP located on the outer periphery into mesh shapes is set. The warp W is an affine transformation set for each of the plurality of triangle areas TA. In other words, in the warp W, an image of triangle areas TA in a sample image SI is transformed into an image of corresponding triangle areas TA in the average shape s₀ by using the affine transformation method. By using the warp W, a transformed sample image SI (also referred to herein as a “sample image SIw”) having the same set positions as those of the characteristic points CP of the average shape s₀ is generated.

In addition, each sample image SIw is generated as an image in which an area (hereinafter, also referred to as a “mask area MA”) other than the average shape area BSA is masked by using the rectangular range including the average shape area BSA (denoted by being hatched in FIG. 8) as the outer periphery. An image area acquired by adding the average shape area BSA and the mask area MA is referred to herein as a reference area BA. In many embodiments, each sample image SIw is normalized, for example, as an image having the size of 56 pixels×56 pixels.

Next, the texture (also referred to herein as an “appearance”) A(x) of a face is modeled by using the following Equation (2) by performing principal component analysis for a luminance value vector that is configured by luminance values for each pixel group x of each sample image SIw. In many embodiments, the pixel group x is a set of pixels that are located in the average shape area BSA.

$$\begin{matrix}Equation ( 2 ) & \\ A ( x ) = {A}_{0} ( x ) + {\sum }_{i = 1}^{m} {λ}_{i} {A}_{i} ( x ) & ( 2 )\end{matrix}$$

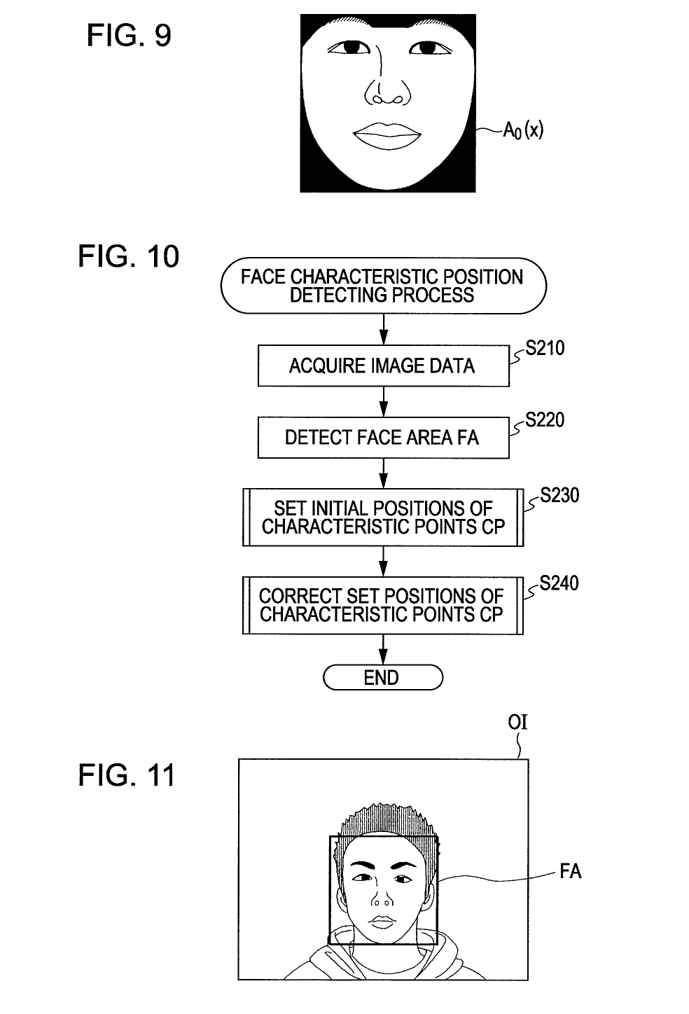

In the above-described Equation (2), A₀(x) is an average face image. FIG. 9 is an explanatory diagram showing an example of the average face image A₀(x). The average face image A₀(x) is an average face of the sample images SIw (see FIG. 8) after the warp W. In other words, the average face image A₀(x) is an image that is calculated by taking an average of pixel values (luminance values) of pixel groups x located within the average shape area BSA of the sample image SIw. Accordingly, the average face image A₀(x) is a model that represents the texture (appearance) of an average face in the average face shape. In addition, the average face image A₀(x), similarly to the sample image SIw, includes an average shape area BSA and a mask area MA and, for example, is calculated as an image having the size of 56 pixels×56 pixels.

In the above-described Equation (2) representing a texture model, Aᵢ(x) is a texture vector, λᵢ is a texture parameter that represents the weight of the texture vector Aᵢ(x). The texture vector Aᵢ(x) is a vector that represents the characteristics of the texture A(x) of a face. In many embodiments, the texture vector Aᵢ(x) is an eigenvector corresponding to an i-th principal component that is acquired by performing principal component analysis. In many embodiments, m eigenvectors set based on the accumulated contribution rates in the order of the eigenvectors corresponding to principal components having the higher contribution rate are used as a texture vector Aᵢ(x). In many embodiments, the first texture vector A1(x) corresponding to the first principal component having the highest contribution rate is a vector that is approximately correlated with a change in the color of a face (may be perceived as a difference in gender).

As shown in the above-described Equation (2), the face texture A(x) representing the outer appearance of a face can be modeled as a sum of the average face image A₀(x) and a linear combination of m texture vectors Aᵢ(x). By appropriately setting the texture parameter λᵢ in the texture model, the face textures A(x) for a wide variety of images can be reproduced. In addition, in many embodiments, the average face image A₀(x) and the texture vector Aᵢ(x) that are set in the texture model setting step (Step S140 in FIG. 2) are stored in the internal memory 120 as the AAM information AMI (FIG. 1).

By performing the above-described AAM setting process (FIG. 2), a shape model that models a face shape and a texture model that models a face texture are set. By combining the shape model and the texture model that have been set, that is, by performing transformation (an inverse transformation of the warp W shown in FIG. 8) from the average shape s₀ into a shape s for the synthesized texture A(x), the shapes and the textures of a wide variety of face images can be reproduced.

### Face Characteristic Position Detecting Process

FIG. 10 is a flowchart showing the steps of a face characteristic position detecting process, in accordance with many embodiments. The face characteristic position detecting process detects the positions of characteristic portions of a face image by determining the disposition of the characteristic points CP in the face image included in the target image by using the AAM technique. As described above, in many embodiments, a total of 68 predetermined positions of a person's facial organs (the eyebrows, the eyes, the nose, and the mouth) and the contour of the face are set as the characteristic portions (see FIG. 4) in the AAM setting process (FIG. 2). Accordingly, the disposition of 68 characteristic points CP that represent predetermined positions of the person's facial organs and the contour of the face is determined.

When the disposition of the characteristic points CP in the face image is determined by performing the face characteristic position detecting process, the values of the shape parameter pᵢ and the texture parameter λᵢ for the face image are determined. Accordingly, the result of the face characteristic position detecting process can be used in an expression determination process for detecting a face image having a specific facial expression (for example, a smiling face or a face with closed eyes), a face-turn direction determining process for detecting a face image positioned in a specific direction (for example, a right-side direction or a lower-side direction), a face transformation process for transforming the shape of a face, a correction process for the shade of a face, or the like.

First, the image processing unit 200 (FIG. 1) acquires image data that represents a target image that is a target for the face characteristic position detecting process (Step S210). For example, when the memory card MC is inserted into the card slot 172 of the printer 100, a thumbnail image of the image file that is stored in the memory card MC can be displayed in the display unit 150. One or a plurality of images that is the target to be processed can be selected by a user through the operation unit 140. The image processing unit 200 acquires the image file that includes the image data corresponding to one or the plurality of images that has been selected from the memory card MC and stores the image file in a predetermined area of the internal memory 120. Here, the acquired image data is referred to herein as target image data, and an image represented by the target image data is referred to herein as a target image OI.

The face area detecting section 230 (FIG. 1) detects an image area that includes at least a part of a face image included in the target image OI as a face area FA (Step S220). The detecting of the face area FA can be performed by using a known face detecting technique. Such known face detecting techniques include, for example, a technique using pattern matching, a technique using extraction of a skin-color area, a technique using learning data that is set by learning (for example, learning using a neural network, learning using boosting, learning using a support vector machine, or the like) using sample images, and the like.

FIG. 11 is an explanatory diagram showing an example of the result of detecting the face area FA in the target image OI. In FIG. 11, a face area FA that is detected from the target image OI is shown. In many embodiments, a face detecting technique is used that detects a rectangle area that approximately includes from the forehead to the chin in the vertical direction of the face and approximately includes the outer sides of both the ears in the horizontal direction as the face area FA.

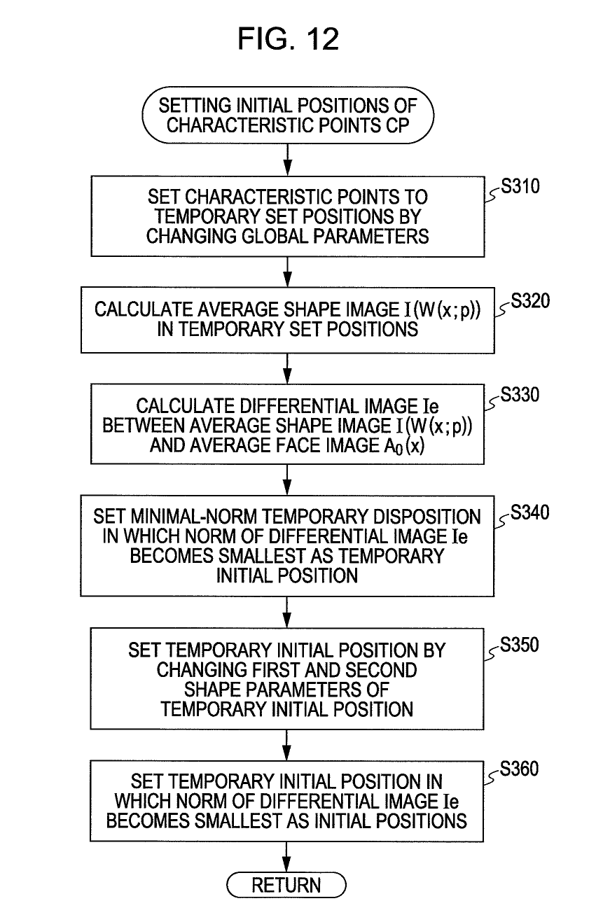

The initial position setting section 210 (FIG. 1) sets the initial positions of the characteristic points CP of the target image OI (Step S230). FIG. 12 is a flowchart showing the steps of an initial position setting process for the characteristic points CP, in accordance with many embodiments. In many embodiments, the initial position setting section 210 sets the characteristic points CP to temporary setting positions on the target image OI by variously changing the values of global parameters that represent the size, the tilt, and the positions (the position in the vertical direction and the position in the horizontal direction)) of the face image with respect to the face area FA and the values of the shape parameter p₁ and the shape parameter p₂ as characteristic amounts (Step S310).

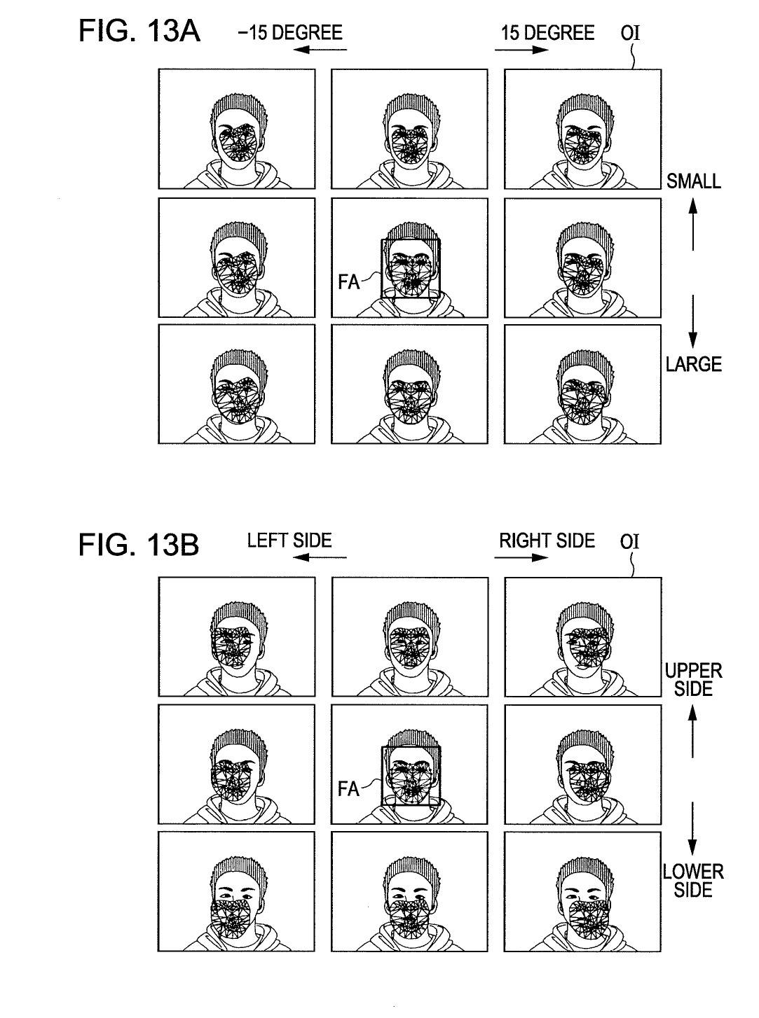

FIGS. 13A and 13B are explanatory diagrams showing exemplary temporary setting positions of the characteristic points CP generated by changing the values of the global parameters. In FIGS. 13A and 13B, meshes formed by joining the characteristic points CP are shown relative to the target image OI for each of the temporary setting positions of the characteristic points CP. The initial position setting section 210, as shown in FIGS. 13A and 13B, sets the temporary setting positions (hereinafter, also referred to as “reference temporary setting positions”) of the characteristic points CP such that the average shape s₀ is formed in the center portion of the face area FA in the center target image OI in both FIGS. 13A and 13B.

The initial position setting section 210 sets a plurality of the temporary setting positions by variously changing the values of the global parameters for the reference temporary setting position. The changing of the global parameters (the size, the tilt, the position in the vertical direction, and the position in the horizontal direction) corresponds to performing enlargement or reduction, a change in the tilt, and parallel movement of the meshes formed by the characteristic points CP with respect to the target image OI. Accordingly, the initial position setting section 210, as shown in FIG. 13A, sets the temporary setting position (shown below or above the reference temporary setting position) for forming the meshes by enlarging or reducing the meshes of the reference temporary setting position by a predetermined scaling factor and the temporary setting position (shown on the right side or the left side of the diagram for the reference temporary setting position) for forming meshes of which the tilt is changed by rotating the meshes of the reference temporary setting position by a predetermined angle in the clockwise direction or the counter-clockwise direction. In addition, the initial position setting section 210 also sets the temporary setting position (shown on the upper left side, the lower left side, the upper right side, and the lower right side of the diagram for the reference temporary setting position) for forming the meshes acquired by performing a transformation combining enlargement or reduction and a change in the tilt for the meshes for the reference temporary setting position.

In addition, as shown in FIG. 13B, the initial position setting section 210 sets the temporary setting position (shown above or below the diagram for the reference temporary setting position) for forming the meshes acquired by performing parallel movement for the meshes for the reference temporary setting position to the upper side or the lower side by a predetermined amount and the temporary setting position (shown on the left side and the right side of the diagram for the reference temporary setting position) for forming meshes acquired by performing parallel movement for the meshes for the reference temporary setting position to the left or right side. In addition, the initial position setting section 210 sets the temporary setting position (shown on the upper left side, the lower left side, the upper right side, and the lower right side of the diagram for the reference temporary setting position) for forming meshes acquired by performing a transformation combining parallel movement to the upper side or the lower side and parallel movement to the left side or the right side for the meshes for the reference temporary setting position.

In addition, the initial position setting section 210 also sets temporary setting positions acquired by performing parallel movement to the upper or lower side and to the left or right side for meshes, shown in FIG. 13B, for eight temporary setting positions other than the reference temporary setting position shown in FIG. 13A. Accordingly, in many embodiments, a total of 81 types of the temporary setting positions are used and include 80 (=3×3×3×3−1) types of temporary setting positions that are set by using combinations of known three-level values for each of four global parameters (the size, the tilt, the position in the vertical direction, and the position in the horizontal direction) and the reference temporary setting position.

The generation portion 212 (FIG. 1) generates an average shape image I(W(x;p)) corresponding to each temporary setting position that has been set (Step S320). FIG. 14 is an explanatory diagram showing an example of the average shape images I(W(x;p)). The average shape image I(W(x;p)) is calculated by performing a transformation of a portion of an input image for which the disposition of the characteristic points CP in the transformed input image is identical to that of the characteristic points CP in the average shape s₀.

The transformation for calculating the average shape image I(W(x;p)), the same as the transformation (see FIG. 8) for calculating the sample images SIw, is performed by the warp W that is a set of affine transformations for each triangle area TA. In particular, an average shape area BSA (an area surrounded by characteristic points CP that are located on the outer periphery of the average shape area BSA) is specified by the characteristic points CP (sees FIGS. 13A and 13B) disposed in the target image OI. Then, by performing the affine transformation for each triangle area TA of the average shape area (BSA) in the target image OI, the average shape image I(W(x;p)) is calculated. In many embodiments, the average shape image I(W(w;p)) has the same shape as the average face image A₀(x), includes the average shape area BSA and a mask area MA, and is calculated as an image having the same size as the average face image A₀(x).

In addition, as described above, the pixel group x is a set of pixels that are located in the average shape area BSA of the average shape S₀. The pixel group in the image (the average shape area BSA of the target image OI) before performing the warp W that corresponds to the pixel group x in the image (the face image having the average shape s₀) after performing the warp W is denoted by W(x;p). Since the average shape image is an image that is configured by the luminance values for each pixel group W(x;p) in the average shape area BSA of the target image OI, the average shape image is denoted by I(W(x;p)). In FIG. 14, nine average shape images I(W(x;p)) corresponding to nine temporary setting positions shown in FIG. 13A are shown.

The calculation portion 214 (FIG. 1) calculates a differential image Ie between the average shape image I(W(x;p)) corresponding to each temporary setting position and the average face image A₀(x) (Step S330). Since 81 types of the temporary setting positions of the characteristic points CP are set, the calculation portion 214 (FIG. 1) calculates 81 differential images Ie.

The initial position setting section 210 calculates the norm from the pixel values of each differential image Ie and sets a temporary setting position (hereinafter, also referred to as a minimal-norm temporary setting position) corresponding to the differential image Ie having the smallest value of the norm as the reference temporary position of the characteristic points CP of the target image OI (Step S340). The pixel value used for calculating the norm may be either a luminance value or an RGB value.

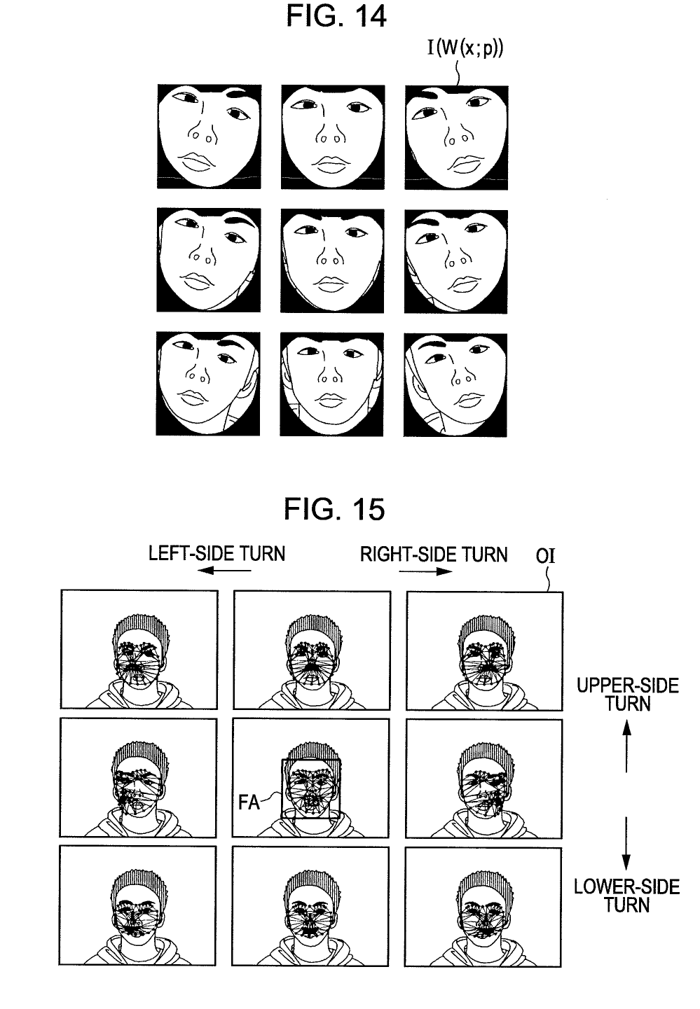

The initial position setting section 210 sets a plurality of temporary initial positions by variously changing the values of the shape parameters p₁ and p₂ as characteristic amounts for the reference temperature position (Step S350). FIG. 15 is an explanatory diagram showing an example of the temporary initial position of the characteristic points CP by changing the value of the characteristic amounts. The changing of the values of the shape parameters p₁ and p₂ corresponds to setting of the initial temporary position acquired by vertically turning the meshes formed by the characteristic points CP as shown in FIG. 7A or the initial temporary position acquired by horizontally turning the meshes formed by the characteristic points CP as shown in FIG. 7B. Accordingly, the initial position setting section 210, as shown in FIG. 15, sets the temporary initial position (shown on the right side or the left side of the diagram for the reference temporary initial position) for forming meshes horizontally turned by a predetermined angle or the temporary initial position (shown on the upper side or the lower side of the diagram for the reference temporary initial position) for forming meshes vertically turned by a predetermined angle. In addition, the initial position setting section 210 also sets the temporary initial positions (shown on the upper left side, the lower left side, the upper right side, or the lower right side of the diagram for the reference temporary initial position) for forming meshes acquired by combining horizontal turn and vertical turn of the meshes for the reference temporary initial position.

The initial position setting section 210 sets eight temporary initial positions in addition to the reference temporary initial position shown in FIG. 15. In other words, a total of nine types of temporary initial positions including eight types (=3×3−1) of the temporary initial positions set by combinations of known three-level values for each of two characteristic amounts (vertical turn and horizontal turn) and the reference temporary initial position are set.

The generation portion 212 (FIG. 1) generates an average shape image I(W(x;p)) corresponding to each temporary initial position that has been set. In addition, the calculation portion 214 (FIG. 1) calculates a differential image Ie between the average shape image I(W(x;p)) corresponding to each temporary initial position and the average face image A₀(x). The initial position setting section 210 calculates the norm of each differential image Ie and sets the temporary initial position corresponding to the differential image Ie having the smallest value of the norm as the initial position of the characteristic positions CP of the target image OI (Step S360). As described above, the initial position setting process for the characteristic points CP is completed.

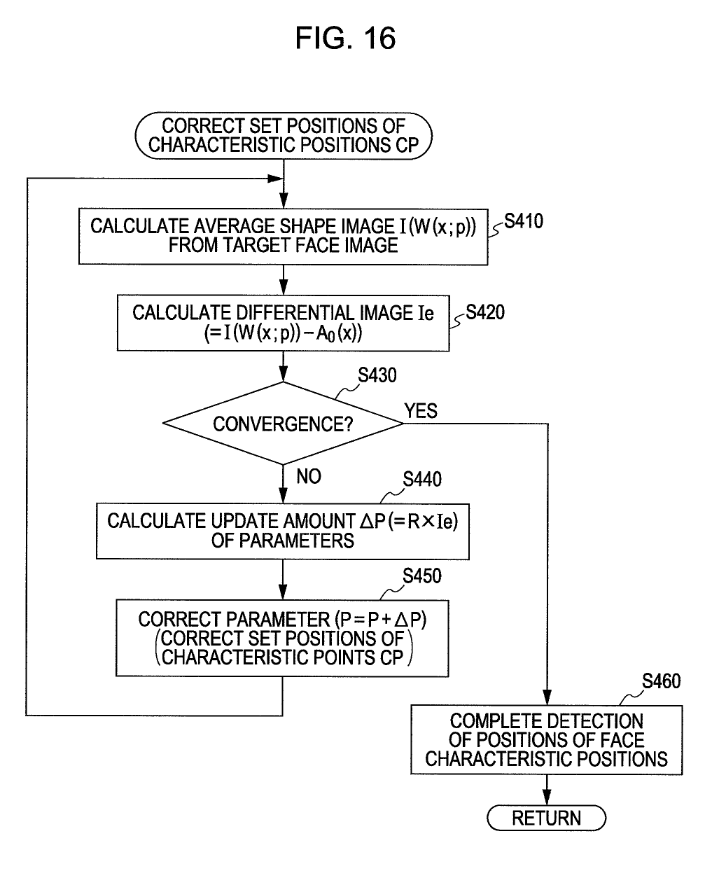

When the initial position setting process for the characteristic points CP is completed, the characteristic position detecting section 220 (FIG. 1) corrects the set position of the characteristic points CP in the target image OI (Step S240). FIG. 16 is a flowchart showing the flow of a process for correcting the characteristic points CP, in accordance with many embodiments.

The generation portion 212 (FIG. 1) calculates an average shape image I(W(x;p)) from the target image OI (Step S410). The method of calculating the average shape image I(W(x;p)) is the same as that in Step S320 of the characteristic point CP initial position setting process.

The characteristic position detecting section 220 calculates a differential image Ie between the average shape image I(W(x;p)) and the average face image A₀(x) (Step S420). The characteristic position detecting section 220 determines whether the process for correcting the characteristic point CP setting position converges based on the differential image Ie (Step S430). The characteristic position detecting section 220 calculates the norm of the differential image Ie. When the value of the norm is smaller than a threshold value set in advance, the characteristic position detecting section 220 determines convergence. On the other hand, when the value of the norm is equal to or lager than the threshold value set in advance, the characteristic position detecting section 220 determines no convergence. Alternatively, the characteristic position detecting section 220 can be configured to determine convergence for a case where the value of the norm of the calculated differential image Ie is smaller than that calculated in Step S430 at the previous time and to determine no convergence for a case where the value of the norm is equal to or larger than the precious value. Furthermore, the characteristic position detecting section 220 can be configured to determine convergence by combining the determination on the basis of the threshold value and the determination on the basis of the comparison with the previous value. For example, the characteristic position detecting section 220 can be configured to determine convergence only for a case where the value of the calculated norm is smaller than the threshold value and is smaller than the previous value and to determine no convergence for other cases.

When no convergence is determined in the above-described convergence determination in Step S430, the correction portion 222 (FIG. 1) calculates an update amount ΔP of the parameter (Step S440). In many embodiments, the update amount ΔP represents the amount of change in the values of the four global parameters (the overall size, the tilt, the position in the X-direction, and the position in the Y-direction) and n shape parameters pᵢ (see Equation (1)) as characteristic amounts. In addition, in many embodiments, right after setting the characteristic points CP to the initial position, the values determined in the initial position setting process (FIG. 12) for the characteristic points CP are set to the global parameters. In such embodiments, since a difference between the initial position of the characteristic points CP and the set position of the characteristic points CP of the average shape s₀ at this moment is limited to a difference of the overall size, the tilt, and the positions, all the values of the shape parameters pᵢ of the shape model are zero.

In many embodiments, the update amount ΔP of the parameters is calculated by using the following Equation (3). In other words, the update amount ΔP of the parameters is product of an update matrix R and the difference image Ie.

Equation (3)

ΔP=R×Ie (3)

The update matrix R represented in Equation (3) is a matrix of M rows×N columns that is set by learning in advance for calculating the update amount ΔP of the parameters based on the differential image Ie and is stored in the internal memory 120 as the AAM information AMI (FIG. 1). In many embodiments, the number M of the rows of the update matrix R is identical to a sum (4+n) of the number (4) of the global parameters and the number (n) of the shape parameters pᵢ, and the number N of the columns is identical to the number (56 pixels×56 pixels−number of pixels included in the mask area MA) within the average shape area BSA of the average face image A₀(x) (FIGS. 6A and 6B). In many embodiments, the update matrix R is calculated by using the following Equations (4) and (5).

$$\begin{matrix}Equation ( 4 ) & \\ R = {H}^{- 1} \sum {[ ∇ {A}_{0} \frac{\partial W}{\partial P} ]}^{T} & ( 4 ) \\ Equation ( 5 ) & \\ H = \sum {[ ∇ {A}_{0} \frac{\partial W}{\partial P} ]}^{T} [ ∇ {A}_{0} \frac{\partial W}{\partial P} ] & ( 5 )\end{matrix}$$

Equations (4) and (5), as well as active models in general, are described in Matthews and Baker, “Active Appearance Models Revisited,” tech. report CMU-RI-TR-03-02, Robotics Institute, Carnegie Mellon University, April 2003, the full disclosure of which is hereby incorporated by reference.

The correction portion 222 (FIG. 1) updates the parameters (four global parameters and n shape parameters pᵢ) based on the calculated update amount ΔP of the parameters (Step S450). Accordingly, the set position of the characteristic points CP in the target image OI is corrected. The correction portion 222 corrects such that the norm of the differential image Ie decreases. After update of the parameters is performed, again, the average shape image I(W(x;p)) is calculated (Step S410) from the target image OI for which the set position of the characteristic points CP has been corrected (Step S410), the differential image Ie is calculated (Step S420), and a convergence determination is made based on the differential image Ie (Step S430). In a case where no convergence is determined in the convergence determination performed again, additionally, the update amount ΔP of the parameters is calculated based on the differential image Ie (Step S440), and correction of the set position of the characteristic points CP by updating the parameters is performed (Step S450).

When the process from Step S410 to Step S450 shown in FIG. 16 is repeatedly performed, the positions of the characteristic points CP corresponding to the characteristic portions of the target image OI approach the positions of actual characteristic portions as a whole. Then, the convergence is determined in the convergence determination (Step S430) at a time point. When the convergence is determined in the convergence determination, the face characteristic position detecting process is completed (Step S460). The set position of the characteristic points CP specified by the values of the global parameters and the shape parameters pᵢ, which are set at that moment, is determined to be the final setting position of the characteristic points CP in the target image OI.

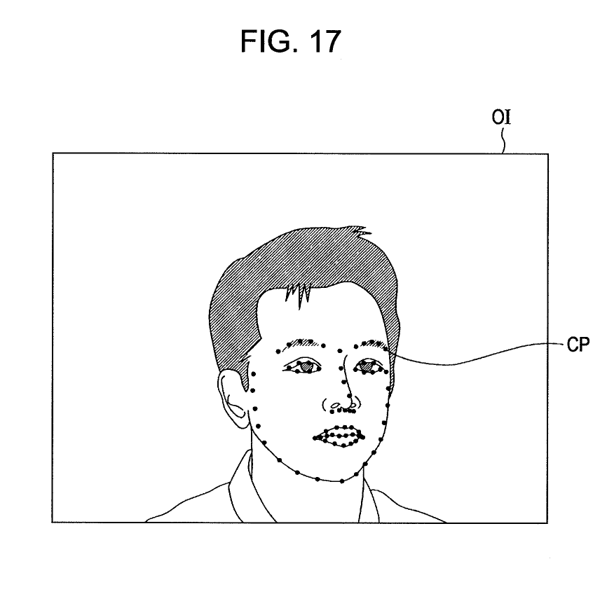

FIG. 17 is an explanatory diagram showing an example of the result of the face characteristic position detecting process. In FIG. 17, the set position of the characteristic points CP that is finally determined for the target image OI is shown. In accordance with the set position of the characteristic positions CP, the positions of the characteristic portions (person's facial organs (the eyebrows, the eyes, the nose, and the mouth) and predetermined positions in the contour of a face) of the target image OI are specified. Accordingly, the shapes and the positions of the person's facial organs and the contour and the shape of the face of the target image OI can be detected.

The print processing unit 320 generates print data for the target image OI for which the shapes and the positions of the facial organs and the contour and the shape of a face are detected. In particular, the print processing unit 320 generates the print data by performing a color conversion process for adjusting pixel values of pixels to the ink used by the printer 100, a halftone process for representing the gray scales of pixels after the color conversion process by distribution of dots, a rasterization process for changing the data sequence of the image data, for which the halftone process has been performed, in the order to be transmitted to the printer 100, and the like for the target image OI. The printing mechanism 160 prints the target image OI for which the shapes and positions of the facial organs and the contour and the shape of the face have been detected based on the print data that is generated by the print processing unit 320. In addition, the print processing unit 320 is not limited to the generation of the print data of the target image OI and can generate print data of an image for which a predetermined process such as face transformation or correction for the shade of a face has been performed based on the shapes and the positions of the detected facial organs or the contour and the shape of a face. In addition, the printing mechanism 160 can print the image, for which a process such as face transformation or correction for the shade of a face has been performed, based on the print data that is generated by the print processing unit 320.

As described above, the initial position of the characteristic points CP can be set in the initial position setting process for the characteristic points CP by using the global parameters and the characteristic amounts. Accordingly, the efficiency and the processing speed of the process for detecting the positions of characteristic portions of a face included in the target image may be improved.

In particular, a plurality of temporary setting positions of the characteristic positions CP that form various meshes can be prepared in advance by changing the values of four global parameters (the size, the tilt, the position in the vertical direction, and the position in the horizontal direction) and two characteristic amounts (the vertical turn and the horizontal turn), and a temporary setting position corresponding to the differential image Ie having the smallest value of the norm is set as the initial position. Accordingly, the initial position of the characteristic points CP in the target image OI can be set to be close to the positions of the characteristic portions of a face. Therefore, correction can be made in an easy manner by the correction portion 222 in the process for correcting the set positions of the characteristic points CP, whereby the efficiency and the processing speed of the process for detecting the positions of the characteristic portions of a face may be improved.

In many embodiments, in the initial position setting process for the characteristic points CP, the initial position setting section 210 sets the initial position of the characteristic points CP by variously changing the shape parameters p₁ and p₂. Accordingly, the positions of characteristic portions of a face that is included in the target image can be effectively detected at a high speed. In particular, the shape parameter p₁ can be a coefficient of the first shape vector s₁ that is approximately correlated with the horizontal turn of a face as the first principal component having the highest contribution rate for the characteristics of a face. In addition, the shape parameter p₂ can be a coefficient of the second shape vector s₂ that is approximately correlated with the vertical turn of a face as the second principal component having the second highest contribution rate for the characteristics of a face. Accordingly, by variously changing the shape parameters p₁ and p₂, a setting position of the characteristic points CP corresponding to various characteristics of a face can be set. Therefore, the initial position of the characteristic points CP in the target image OI can be set to be close to the positions of the characteristic portions of a face.

In many embodiments, the target image OI for which the shapes and the positions of facial organs or the contour and the shape of a face have been detected can be printed. Accordingly, after an expression determination process for detecting a face image having a specific facial expression (for example, a smiling face or a face with closed eyes) or a face-turn direction determining process for detecting a face image positioned in a specific direction (for example, a right-side direction or a lower-side direction) is performed, any arbitrary image can be selected and printed based on the result of the determination. In addition, an image for which a predetermined process such as face transformation or shade correction for a face has been performed based on the shapes and the positions of facial organs or the contour and the shape of a face that have been detected can be printed. Accordingly, after face transformation or face-shade correction, or the like is performed for a specific face image, the face can be printed.

### Exemplary Variations

Furthermore, the present invention is not limited to the above-described embodiments or examples. Thus, various embodiments can be performed without departing from the scope of the base idea of the present invention. For example, the modifications described below can be made.

The initial position setting section 210 can determine a reference temporary initial position having the smallest norm of the differential image Ie out of temporary setting positions that are set by variously changing the values of the global parameters, and the temporary initial position can be set by variously changing the characteristic amount of the reference temporary initial position.

The initial position can be set from among a total of 729 types (=3×3×3×3×3×3) of temporary setting positions by setting the temporary setting positions that are acquired by performing parallel movement in the vertical or the horizontal direction, shown in FIG. 13B and the vertical turn or the horizontal turn, shown in FIG. 14, for meshes formed in eight temporary setting positions other than the reference temporary setting position shown in FIG. 13A. Even in such a case, the initial position of the characteristic points CP in the target image OI can be set to be close to the positions of the characteristic portions of a face. Accordingly, the efficiency and the processing speed of the process for detecting the positions of the characteristic portions of a face may be improved.

In many embodiments, a total of 80 types (=3×3×3×3−1) of the temporary setting positions corresponding to combinations of three-level values for each of four global parameters (the size, the tilt, the position in the vertical direction, and the positions in the horizontal direction) are set in advance for the initial position setting process for the characteristic points CP. However, the types and the number of the parameters and the number of levels of parameter values that are used for setting the temporary setting positions can be changed. For example, only some of the four global parameters can be configured to be used for setting the temporary setting positions, and the temporary setting positions can be set in accordance with combinations of five-level values for each used parameter.

In many embodiments, the temporary initial positions are set in accordance with combinations of three-level values of the shape parameters p₁ and p₂ corresponding to two principal components in the descending order of the contribution rates for the initial position setting process for the characteristic points CP. However, the number of the shape parameters pᵢ or the number of the levels of the parameter values can be changed. For example, only the shape parameter pᵢ corresponding to one principal component having the highest contribution rate can be configured to be used. Alternatively, the shape parameters pᵢ corresponding to three principal components or more selected from the highest contribution rate side can be configured to be used. In addition, for example, the number of levels of the parameter values can be set to five.

In many embodiments, the correction process for the positions of the characteristic points CP calculates the average shape image I(W(x;p)) based on the target image OI and the setting position of the characteristic points CP of the target image OI is matched to the set position of the characteristic points CP of the average face image A₀(x). However, both the dispositions of the characteristic points CP can be configured to be matched to each other by performing an image transformation for the average face image A₀(x).

The sample image SI (FIG. 3) described above is only an example, and the number and the types of images used as the sample images SI can be varied. In addition, the above-described predetermined characteristic portions (see FIG. 4) of a face that are represented in the positions of the characteristic points CP are only an example. Thus, some of the characteristic portions set in the above-described embodiments can be omitted, and/or other facial portions can be used as the characteristic portions.

In addition, the texture model can be set by performing principal component analysis for the luminance value vector that is configured by luminance values for each pixel group x of the sample image SIw. The texture model can also be set by performing principal component analysis for index values (for example, RGB values) other than the luminance values that represent the texture (appearance) of the face image.

In addition, the size of the average face image A₀(x) is not limited to 56 pixels×56 pixels and can be configured to be different. In addition, the average face image A₀(x) need not include the mask area MA (FIG. 8) and can include only the average shape area BSA. Furthermore, instead of the average face image A₀(x), a different reference face image that is set based on statistical analysis for the sample images SI can be used.

In addition, in many embodiments, the shape model and the texture model that are used are set by using the AAM technique. The shape model and the texture model can also be set by using any other suitable modeling technique (for example, a technique called a Morphable Model or a technique called an Active Blob).

In addition, in many embodiments, the image stored in the memory card MC is configured as the target image OI. However, for example, the target image OI can also be an image that is acquired through a network.

In addition, in many embodiments, the image processing is performed by using a printer (e.g., the printer 100) as an image processing apparatus as described above. However, a part of or all of the processing can be performed by an image processing apparatus of any other suitable type such as a personal computer, a digital still camera, or a digital video camera. In addition, the printer 100 is not limited to an ink jet printer and can be a printer of any other suitable type such as a laser printer or a sublimation printer.

In addition, a part of the configuration that is implemented by hardware can be replaced by software. Likewise, a part of the configuration implemented by software can be replaced by hardware.

In addition, in a case where a part of or the entire function according to an embodiment of the invention is implemented by software (computer program), the software can be provided in a form being stored on a computer-readable recording medium. The “computer-readable recording medium” in an embodiment of the invention is not limited to a portable recording medium such as a flexible disk or a CD-ROM and includes various types of internal memory devices such a RAM and a ROM and an external memory device of a computer such as a hard disk that is fixed to a computer.

Other variations are within the spirit of the present invention. Thus, while the invention is susceptible to various modifications and alternative constructions, certain illustrated embodiments thereof are shown in the drawings and have been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

What is claimed is:

1. An image processing apparatus that detects coordinate positions of characteristic portions of a face image in a target image, the image processing apparatus comprising:
a processor; and
a machine readable memory coupled with the processor and comprising instructions that when executed cause the processor to
identify a face area of the target image that includes at least a portion of the face image,
generate initial coordinate positions for the characteristic portions by using
one or more predetermined parameters relating to a size, an angle, or a position of the face image in the face area, and
one or more predetermined characteristic amounts representing characteristics of the face image,
generate corrected coordinate positions for the characteristic portions by modifying the initial coordinate positions or previously generated corrected coordinate positions so as to approach the characteristic portions in the target image, and
detect the corrected coordinate positions as the coordinate positions of the characteristic portions of the face image.

2. The image processing apparatus according to claim 1, wherein the initial coordinate positions are generated from one of a plurality of candidate sets of initial coordinate positions that are set in advance by using predetermined values of the parameters and the characteristic amounts.

3. The image processing apparatus according to claim 2, wherein:
the memory further comprises instructions that when executed cause the processor to
generate each of a plurality of average shape images from the target image by transforming a part of the target image into a reference average face image shape based on a corresponding set of the candidate sets of initial coordinate positions,
generate a differential image between each of the average shape images and a reference average face image having the reference average face image shape, the reference average face image having coordinate positions of its characteristic portions based on a plurality of sample face images, and
generate the initial coordinate positions from the candidate set of initial coordinate positions corresponding to the differential image having the smallest value for its norm.

4. The image processing apparatus according to claim 1, wherein:
the one or more characteristic amounts comprise one or more coefficients of a corresponding one or more shape vectors that are acquired by performing principal component analysis on coordinate positions of characteristic portions included in the plurality of sample images; and
the initial coordinate positions are generated by using coefficients of one or more shape vectors out of the shape vectors in descending order of contribution rate for the characteristics of the face image.

5. The image processing apparatus according to claim 1, wherein the initial coordinate positions are generated by using the characteristic amount that represents face-turn of the face image in the horizontal direction.

6. The image processing apparatus according to claim 1, wherein the initial coordinate positions are generated by using the characteristic amount that represents face-turn of the face image in the vertical direction.

7. The image processing apparatus according to claim 3, wherein:
the corrected coordinate positions are generated so as to decrease the norm of a differential image between the reference average face image and an average shape image corresponding to the initial coordinate positions or previously generated corrected coordinate positions, and
the corrected coordinate positions are detected as the coordinate positions of the characteristic portions of the face image when the norm of the differential image is equal to or less than a predetermined value.

8. The image processing apparatus according to claim 1, wherein the characteristic portions comprise an eyebrow, an eye, a nose, a mouth, and a face line.

9. The image processing apparatus according to claim 1, wherein the image processing apparatus comprises at least one of a printer, a personal computer, a digital camera, or a digital video camera.

10. An image processing method for detecting coordinate positions of characteristic portions of a face image in a target image, using a computer method comprising:
identifying a face area of the target image that includes at least a portion of the face image;
determining initial coordinate positions for the characteristic portions by using
one or more predetermined parameters relating to a size, an angle, or a position of the face image in the face area, and
one or more predetermined characteristic amounts representing characteristics of the face image,
determining corrected coordinate positions for the characteristic portions by modifying the initial coordinate positions or previously generated corrected coordinate positions so as to approach the characteristic portions in the target image, and
identifying the corrected coordinate positions as the coordinate positions of the characteristic portions of the face image.

11. The method according to claim 10, wherein the initial coordinate positions are determined from one of a plurality of candidate sets of initial coordinate positions that are set in advance by using predetermined values of the parameters and the characteristic amounts.

12. The method according to claim 11, further comprising:
generating each of a plurality of average shape images from the target image by transforming a part of the target image into a reference average face image shape based on a corresponding set of the candidate sets of initial coordinate positions;
generating a differential image between each of the average shape images and a reference average face image having the reference average face image shape, the reference average face image having coordinate positions of its characteristic portions based on a plurality of sample face images, and
generating the initial coordinate positions from the candidate set of initial coordinate positions corresponding to the differential image having the smallest value for its norm.

13. The method according to claim 10, wherein:
the one or more characteristic amounts comprise one or more coefficients of a corresponding one or more shape vectors that are acquired by performing principal component analysis on coordinate positions of characteristic portions included in the plurality of sample images; and
the initial coordinate positions are generated by using coefficients of one or more shape vectors out of the shape vectors in descending order of contribution rate for the characteristics of the face image.

14. The method according to claim 10, wherein the initial coordinate positions are generated by using the characteristic amount that represents face-turn of the face image in the horizontal direction.

15. The method according to claim 10, wherein the initial coordinate positions are generated by using the characteristic amount that represents face-turn of the face image in the vertical direction.

16. The method according to claim 12, wherein:
the corrected coordinate positions are generated so as to decrease the norm of a differential image between the reference average face image and an average shape image corresponding to the initial coordinate positions or previously generated corrected coordinate positions, and
the corrected coordinate positions are detected as the coordinate positions of the characteristic portions of the face image when the norm of the differential image is equal to or less than a predetermined value.

17. The method according to claim 10, wherein the characteristic portions comprise an eyebrow, an eye, a nose, a mouth, and a face line.

18. A tangible medium containing a computer program implementing the method as in any one of claim 10, 11, 12, 13, 14, 15, 16, or 17.
